(19) United States
(12) Patent Application Publication
(10) Pub. No.: US 2010/0001169 A1
(43) Pub. Date: Jan. 7, 2010

(54) VEHICLE SEAT MOUNTING DEVICE

(76) Inventors: Sverker Armö, Eskilstuna (SE); Claes-Göran Svensson, Moheda (SE); Kel Loewen, Goderich (CA); Henrik Loserius, Trier (DE); Gunnar Erixon, Kungsangen (SE); Fredrik Börjesson, Sollentuna (SE)

Correspondence Address: WRB-IP LLP, 1217 KING STREET, ALEXANDRIA, VA, 22314, US

(21) Appl. No.: 12/279,193

(22) PCT Filed: Feb. 13, 2006
(86) PCT No.: PCT/SE06/00200

§ 371 Date: Oct. 23, 2008

(51) Int. Cl. B60N 2/04; B60N 2/38; B60N 2/24; B60N 2/06; B60N 2/14

(52) U.S. Cl. 248/636; 296/65.11

(57) ABSTRACT

A vehicle seat mounting device includes a first component for attachment to a vehicle and a second component for attachment to a vehicle seat. The device further includes an arrangement for connecting the first and second components to each other such that the first component and the second component are adjustable relative to each other by pivoting the first component and the second component relative to each other around a substantially vertical geometrical pivot axis. At least one of the first and second components includes a first unit and a second unit which are displaceable relative to each other in a direction parallel to a substantially horizontal plane, and an arrangement for damping a relative displacement motion of the first and second units in the direction so as to reduce horizontal vibrations in the vehicle seat when the device is installed for use in the vehicle.

### BACKGROUND AND SUMMARY

The present invention relates to a vehicle seat mounting device.

The invention is applicable on different types of vehicle seats and vehicles, in particular as a seat module for construction equipment vehicles such as wheel loaders, articulated haulers, and excavators, but also for agriculture machines, trucks and the like.

EP 1 367 474 discloses a seat apparatus for an industrial vehicle. The seat has a rotating mechanism for enabling rotational movement of the seat relative to the vehicle, and seat slides for adjustment of the seat in the fore-and-aft direction. Such a seat apparatus may fulfil the requirements for individual adjustment of the seat to ensure the requisite position for an operator and the operator's visibility.

In addition to the adjustment of the seat position, there is often a desire to minimize the vibrations transferred from the vehicle to the operator so as to make the seat more ergonomic and prevent abatement of fingers or injuries of the operator of the vehicle due to such vibrations. Vibrations in the vertical direction are reduced by the shock absorbers of the vehicle and/or the suspension of the seat itself. This contributes to improved comfort. However, in a seat of an industrial vehicle there are also often vibrations in the horizontal plane which affect the operator negatively. Up to now dampers for reducing vibrations in the horizontal plane have been in the form of additional equipment provided as separate units. When installed, such a unit increases the total height of the vehicle seat mounting device in an undesired way.

It is desirable to provide a vehicle seat mounting device of the type mentioned by way of introduction, which device can reduce vibrations in the horizontal plane when installed for use in a vehicle. Particularly, an aspect of the invention provides such a device which enables the vibrations to be reduced at the same time as the rotation and length adjustment possibilities are maintained in a compact design having a relatively low height.

By such a device wherein at least one of said first and second components has a first unit and a second unit which are displaceable relative to each other in a direction parallel to a substantially horizontal plane, and a means for damping a relative displacement motion of the first and second units in said direction so as to reduce horizontal vibrations in the vehicle seat when the device is installed for use in the vehicle, the vibrations can be reduced and at the same time the invention enables the ordinary adjustment functions of the seat to be fulfilled.

By the provision of a means for connecting the first and second component to each other such that the first component and the second component are adjustable relative to each other by pivoting the first component and the second component relative to each other around a substantially vertical geometrical pivot axis, a rotation adjustment of the seat is obtained. For example, the first and second components may be connected to each other by means of a pivot mechanism such as a turn table or the like. The length adjustment of the seat may be obtained by arranging the first component displaceable relative to the vehicle by means of slide rails for instance.

Other advantageous features and functions of different embodiments of the invention according to the invention appear from the following detailed description.

### BRIEF DESCRIPTION OF THE DRAWINGS

With reference to the appended drawings, below there follows a more detailed description of preferred embodiments of the invention provided merely as non-limiting examples.

In the drawings:

FIG. 1 is a schematic perspective view of a device according to the invention,

FIG. 2 is a schematic perspective view illustrating the device according to the invention when installed between a vehicle floor and a vehicle seat,

FIG. 3 is a schematic front view of the device in FIG. 1,

FIG. 4 is a schematic lateral view of the device in FIG. 1,

FIG. 5 is a partly cut perspective view of a device according to the invention.

### DETAILED DESCRIPTION

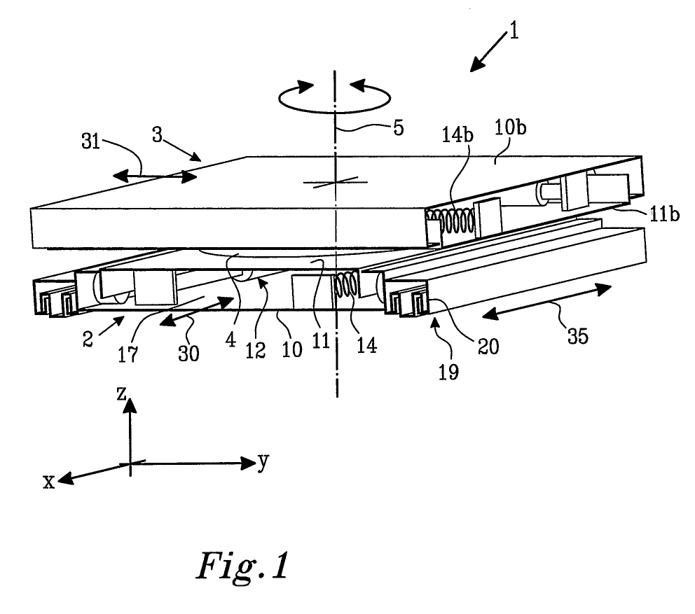

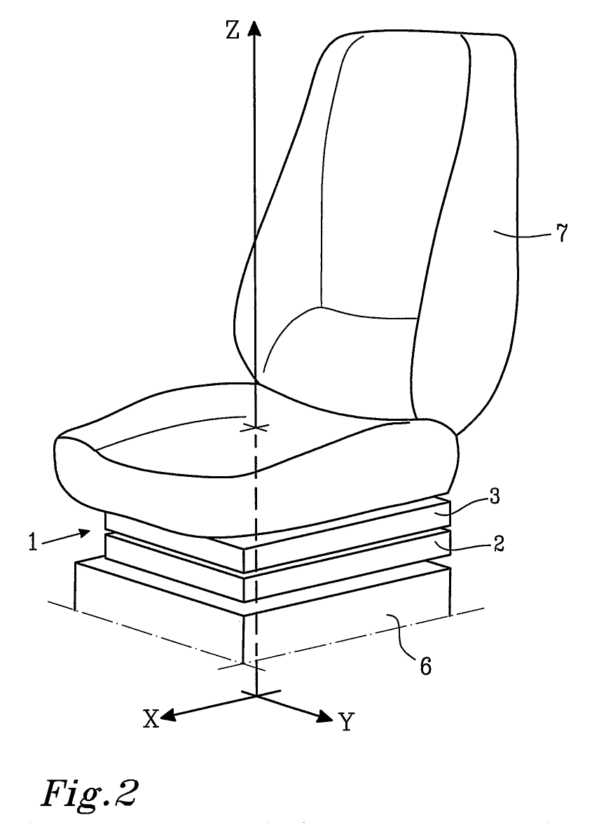

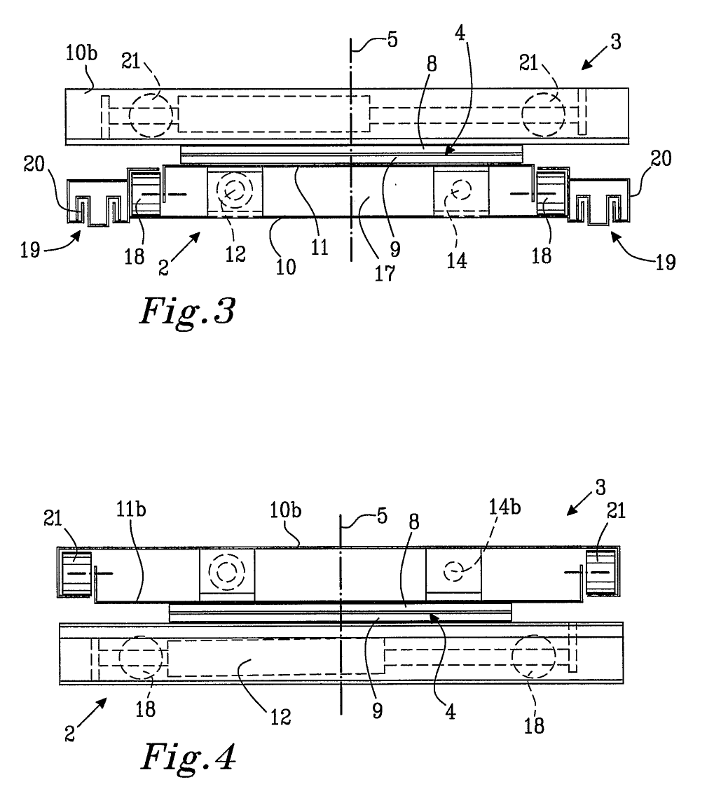

FIG. 1 is a perspective view illustrating a vehicle seat mounting device 1 according to the invention. The device 1 comprises a first component 2 for attachment to a vehicle and a second component 3 for attachment to a vehicle seat. The device further comprises a means 4 for connection of said first and second components to each other. The first and second components 2, 3 are connected for allowing rotational adjustment of the seat by pivoting the first and second components relative to each other. The first and second components 2, 3 are connected to each other such that the first component and the second component are adjustable relative to each other by pivoting the first component and the second component relative to each other around a substantially vertical geometrical pivot axis 5. In FIG. 2 the vehicle seat mounting device 1 is installed between a vehicle floor 6 and a vehicle seat 7. The vehicle seat mounting device 1 can be installed by attachment of the first component 2 directly to the vehicle as illustrated, or the vehicle seat mounting device can be attached to a damping module for reducing vibrations in the Z-direction which damping module is in turn attached to the vehicle. As appears from lateral views in FIGS. 3 and 4, for instance, the connection means 4 can comprise a pivot plate 8 constituting a part of the second component 3, and a base plate 9 constituting a part of the first component 2. The pivot plate 8 is pivotally supported relative to the base plate 9. A bearing mechanism comprising a roller bearing or a low friction slide can be used for supporting the pivot plate 8 relative to the base plate 9.

Furthermore, mechanical stops (not illustrated) may be arranged to allow the operator to turn the seat within a certain angle interval only. The angular adjustment range is suitably in the interval ±15° to ±300°, depending on the available space in the cab of the vehicle. For the vehicle seat mounting devices produced for the backhoe loader market, the second component is preferably allowed to be released from the mechanical stops and pivoted relative to the first component by the operator for turning the seat 180°.

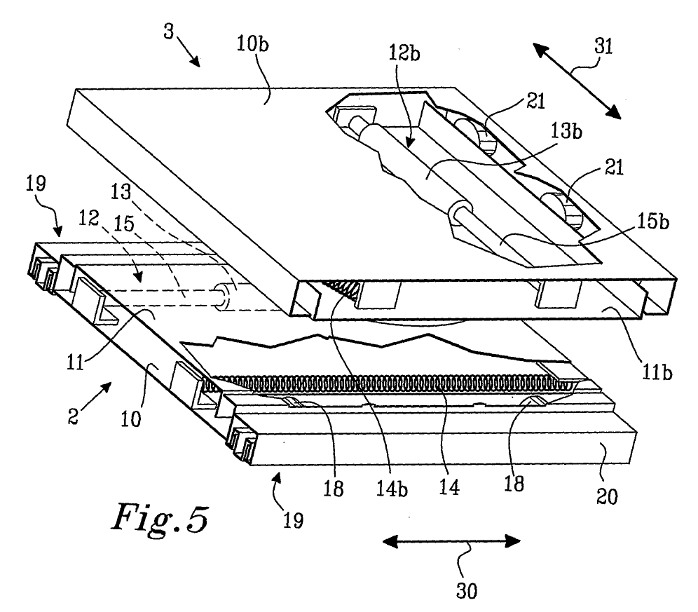

According to the invention at least one of said first and second components 2, 3 has a first unit 10 and a second unit 11 which are displaceable relative to each other in a direction 30 substantially parallel with a horizontal plane. This is to enable damping of vibrations in the horizontal plane by means of a damping means 12. In this respect, see also the partly cut perspective view in FIG. 5, where the first and second components have been spaced apart from each other only for the sake of clarity. The damping means 12 is arranged for damping a relative displacement motion of the first and second units 10, 11 in said direction 30 so as to reduce horizontal vibrations in the vehicle seat 7 when the device 1 is installed for use in the vehicle. In a preferred embodiment of the invention, each of the first and second components 2, 3 comprises a set of said first 10 and second units 11 and said means 12 for damping a relative displacement motion of the first and second units 10, 11. The first and second units 10, 11 and damping means 12 of the first component 2 are arranged to reduce vibrations in a first direction 30, and the first and second units 10b, lib and damping means 12b of the second component 3 are arranged to reduce vibrations in a second direction 31 substantially perpendicular to the first direction 30, though in the same plane.

The first component 2 preferably has a first unit 10 and a second unit 11 which are rectilinearly displaceable relative to each other along a geometrical line intended to be substantially parallel with the fore-and-aft direction X of the vehicle. For simplicity, this direction is hereinafter called the X-direction. The second component 3 preferably has a first unit 10b and a second unit lib which are rectilinearly displaceable relative to each other along a geometrical line intended to be substantially perpendicular to the fore-and-aft direction X of the vehicle. This direction is hereinafter called the Y-direction. Thus, vectors of the X- and Y-directions define the horizontal plane. In case the second component 3 is rotated relative to the first component 2 and thus relative to the vehicle by means of the connection means 4, a turn-table for instance, the new displacement direction of the units 10b, lib of the second component 3 is of course somewhat changed and no longer parallel with the Y-direction.

Although the damping means 12, 12b preferably comprises a damper connecting the first 10, 10b and second units 11, lib, other types of damper loosely arranged between the first unit and the second unit could also be used, such as rubber shock absorber etc. Preferably, a damper in the form of a pneumatic or hydraulic piston/cylinder-member to counteract the displacement motion is used. The piston/cylinder-member is suitably arranged in a direction substantially parallel with the intended displacement direction. That is to say, in accordance with the example illustrated, a first cylinder 13 is arranged in the X-direction connecting the first and the second unit of the first component 2, whereas a second cylinder 13b is arranged in the Y-direction connecting the first and the second units of the second component 3. A piston 15 of the piston/cylinder member 12 is attached to one of the first and second units and the cylinder 13 is attached to the other of the units.

However, the damping means 12, 12b could also be accompanied by one or more additional springs 14, 14b, such as a helical spring or the like. Such a spring is arranged to take up forces in the same direction as the damping means 12, 12b, i.e. arranged in parallel with the damper.

As appears from FIG. 3, the first component 2 and/or the second component 3 are preferably built up by first and second units 10, 11; 10b, lib in the shape of folded and/or pressed or punched panels which panels are arranged spaced apart from each other. The panels can be made of sheet steel. This enables the present damping means 12 to be arranged within the device 1, i.e. inside the current component, in a space 17 between the first unit 10 and the second unit 11. If one said additional spring 14 is utilised, such a spring can also be arranged within the device 1 in the same way.

The stroke length of the damped displacement motion can be varied according to the vibrations and other circumstances. Suitably, the stroke length is in the interval ±10 mm to ±50 mm in the X-direction as well as in the Y-direction, and preferably approximately ±35 mm. In some applications the stroke length can be adjustable so as to adapt the damping function to the present conditions. In such a case an adjustable damper is suitably used.

The first unit 10 of the first component 2 can be a first panel provided with means for receiving rollers 18 of the second unit 11 of the first component 2. By means of the rollers 18, the first and second units are displaceable relative to each other in the X-direction to obtain a damped motion as previously described. Although, rolling means having low friction is advantageously used for the displacement motion, in another embodiment of the invention sliding means could also be used for the displacement motion.

The first component 2 is to be connected to a vehicle, for example by screw or bolt joints or similar. Furthermore, the first unit 10 of the first component 2 can comprise additional means 19 for adjustment of the seat 7 relative to the vehicle. The additional seat-adjustment means 19 is arranged for adjusting the seat backwardly and forwardly in a direction 35 intended to be substantially parallel with the fore-and-aft direction of the vehicle, i.e. the X-direction (see FIG. 1). The adjustment range is suitably in the interval ±20 mm to ±140 mm, and preferably approximately ±80 mm. This additional seat-adjustment means may comprise slide rails 20 or rails for rollers, and any suitable locking means for locking the seat 7 in a selected position along the X-direction.

Thus, the seat 7 illustrated in FIG. 2 can be adjusted in the X-direction and locked in the desired position by means of the additional seat-adjustment means 19, around which position the damped displacement motion in the X-direction of the seat relative the vehicle takes place.

With reference to FIG. 3, the second unit 11 of the first component 2 can be a second panel supported by the rollers 18. The first and second panels are arranged spaced apart so as to enable the arrangement of the damping means 12 between the plates. The base plate 9 for the pivot movement may be constituted by the second plate 11 or the base plate can be arranged as an additional plate on the top of the second unit 11.

The first unit 10b of the second component 3 may have the same shape as the first unit of the first component, except for the seat-adjustment means which is unnecessary (see FIG. 4). This unit 10b is arranged uppermost of the device 1 and is supported by rollers 21 arranged on the second unit lib of the second component 3. The pivot plate 8 is constituted by the second unit lib provided with the rollers 21 or alternatively an additional plate is arranged at the underside of the second unit as the pivot plate. Thus, in the illustrated example the first and second units 10b, lib of the second component 3 are arranged inverted compared to the first and second units 10, 11 of the first component 2. The second component 3 is to be connected to a seat 7, for example by screw or bolt joints or similar.

The second component 3 is arranged above the first component 2 such that the first component and the second component overlap with each other when viewed in a vertical direction Z. To save space also in the horizontal plane the first and second components 2, 3 substantially entirely overlap with each other. Preferably both the first and second components are centered relative to the vertical pivot axis 5.

It is to be understood that the present invention is not limited to the embodiments described above and illustrated in the drawings; rather, the skilled person will recognize that many changes and modifications may be made within the scope of the appended claims.

1. A vehicle seat mounting device comprising a first component for attachment to a vehicle and a second component for attachment to a vehicle seat, and a means for connecting the first and second components to each other such that the first component and the second component are adjustable relative to each other by pivoting the first component and the second component relative to each other around a substantially vertical geometrical pivot axis, wherein one of the first and second components comprises a first unit and a second unit which are displaceable relative to each other in a direction parallel to a substantially horizontal plane, and a means for damping a relative displacement motion of the first and second units in the direction so as to reduce horizontal vibrations in the vehicle sea when the device is installed for use in the vehicle, and wherein the first unit and the second unit are rectilinearly displaceable relative to each other along a geometrical line intended to be substantially parallel with a fore-and-aft direction of the vehicle, wherein the other of the first and second components comprises a first unit and a second unit, which are rectilinearly displaceable relative to each other along a geometrical line intended to be substantially perpendicular to the fore-and-aft direction of the vehicle.

2. A device according to claim 1, wherein one of either the first unit or the second unit is provided with rolling means for the displacement motion.

3. A device according to claim 1, wherein at least one of the first unit and the second unit is provided with sliding means for the displacement motion.

4. A device according to claim 1, wherein the damping means comprises a damper connecting the first and second units.

5. A device according to claim 4, wherein the damper is adjustable so as to enable adjustment of the stroke length of the damped displacement motion.

6. A device according to claim 4, wherein the damper is a piston/cylinder-member.

7. A device according to claim 1, wherein the damping means is arranged within the device in a space between the first unit and the second unit.

8. A device according to claim 1, wherein in addition to the damping means at least one spring is arranged for taking up forces in the same direction as the damping means.

9. A device according to claim 8, wherein the spring is arranged within the device in a space between the first unit and the second unit.

10. A device according to claim 1, wherein each of the first and second components comprise a set of so the first and second units and the means for damping a relative displacement motion of the first and second units said the first and second units and damping means of the first component being arranged to reduce vibrations in a first direction, and the first and second units and damping means of the second component being arranged to reduce vibrations in a second direction substantially perpendicular to the first direction.

11. A device according to claim 1, wherein the first component comprises additional means for adjustment of the seat relative the vehicle.

12. A device according to claim 11, wherein the additional seat adjustment means is arranged for adjusting the seat backwardly and forwardly in a direction intended to be substantially parallel with the fore-and-aft direction of the vehicle.

13. A device according to claim 11, wherein the additional seat-adjustment means comprises slide rails.

14. A device according to claim 1, wherein the connection means comprises a rotating plate being a part of the second component, and a base plate being a part of the first component, the rotating plate being rotatably supported relative to the base plate.

15. A device according to claim 1, wherein the second component is arranged above the first component such that the first component and the second component overlap with each other when viewed in a vertical direction.

16. A device according to claim 15, wherein the first and second components substantially entirely overlap with each other.

17. An industrial vehicle comprising a vehicle seat mounting device according to claim 1.
